(19) United States
(12) Patent Application Publication
(10) Pub. No.: US 2025/0070198 A1
(43) Pub. Date: Feb. 27, 2025

(54) Apparatus And Method For A Hydrogen Powered Generator

(71) Applicant: Prometheus Energy Group, LLC, St. Charles, IL (US)

(72) Inventor: Nicolas Kernene, St. Charles, IL (US)

(21) Appl. No.: 18/942,753

(22) Filed: Nov. 10, 2024

Related U.S. Application Data
(63) Continuation of application No. PCT/US2023/066972, filed on May 12, 2023.
(60) Provisional application No. 63/342,484, filed on May 16, 2022.

(51) Int. Cl. H01M 8/04082

(52) U.S. Cl. CPC H01M 8/04201

(57) ABSTRACT

A hydrogen powered generator includes at least one fuel cell, a power converter that receives a raw power from the at least one fuel cell and outputs a converted power; and a hydrogen storage assembly that supplies hydrogen to the at least one fuel cell. The hydrogen storage assembly comprises a first hydrogen storage unit in fluid communication with the at least one fuel cell and a second hydrogen storage unit in fluid communication with the at least one fuel cell. The first hydrogen storage unit, the second hydrogen storage unit, and the fuel cell can be mounted on a tray that slides out of the generator to facilitate maintenance. The power converter can include one or more blades that can be swapped into the power converter to meet various power conversion needs.

### RELATED APPLICATIONS

The present application is a continuation application of PCT/US/2023/066972 filed May 12, 2023, which claims priority to U.S. Provisional Patent Application No. 63/342,484 filed May 16, 2022. The entire content of the foregoing applications is incorporated herein by reference.

### TECHNICAL FIELD

Embodiments of the technology relate generally to a generator comprising a power converter, at least one fuel cell, and a hydrogen storage assembly.

### BACKGROUND

Hydrogen is the object of significant research as an alternate fuel source to fossil fuels. Hydrogen is attractive because (i) it can be produced from many diverse energy sources, (ii) it has a high energy content by weight (about three times more than gasoline) and (iii) it has a zero-carbon emission footprint-the by-products of hydrogen combustion being oxygen and water.

However, hydrogen has physical characteristics that make it difficult to store in large quantities without taking up a significant amount of space. Despite hydrogen's high energy content by weight, hydrogen has a low energy content by volume. This makes hydrogen difficult to store, particularly within the size and weight constraints of a vehicle, for example. Another major obstacle is hydrogen's flammability and the concomitant safe storage thereof.

Known hydrogen storage technologies directed to high pressure tanks with compressed hydrogen gas and/or cryogenic liquid hydrogen storage have shortcomings because the risk of explosion still exists. These approaches require pressurized containers that are heavy and also require high energy input-features that detract from commercial viability.

Metal alloy hydrogen storage is based on materials capable of absorbing and releasing the hydrogen. Metal alloy hydrogen storage provides high energy content by volume, reduces the risk of explosion, and eliminates the need for high pressure tanks and insulation devices. Examples of hydrogen storage devices using metal alloys are described in U.S. Pat. No. 9,841,147 to Kernene.

Leveraging the benefits of hydrogen requires systems that facilitate broader use of hydrogen as an energy source. Portable generators that are powered by hydrogen represent one type of system that can facilitate broader use of hydrogen as an energy source.

### SUMMARY

The present disclosure is generally directed to a generator powered by hydrogen gas. In one example embodiment, the hydrogen powered generator can comprise at least one fuel cell; a power converter that receives a raw power from the at least one fuel cell and outputs a converted power; and a hydrogen storage assembly that supplies hydrogen to the at least one fuel cell, the hydrogen storage assembly comprising a first hydrogen storage unit in fluid communication with the at least one fuel cell and a second hydrogen storage unit in fluid communication with the at least one fuel cell.

The foregoing example embodiment can include one or more of the following features. In the example hydrogen powered generator, the first hydrogen storage unit and the second hydrogen storage unit can be cylindrical and comprise a metal alloy material that absorbs and releases hydrogen gas. The hydrogen storage assembly can comprise a tray that slides out of the hydrogen powered generator, wherein the first hydrogen storage unit and the second hydrogen storage unit are mounted on the tray and the at least one fuel cell can be mounted on the tray. The first hydrogen storage unit and the second hydrogen storage unit each can have a port for injecting hydrogen into and releasing hydrogen from the first hydrogen storage unit and the second hydrogen storage unit. The first hydrogen storage unit and the second hydrogen storage unit each can be subdivided into multiple chambers, each of the multiple chambers comprising a metal alloy material that absorbs and releases hydrogen gas. The first hydrogen storage unit and the second hydrogen storage unit each can comprise an inlet port and an outlet port at opposite ends of the first hydrogen storage unit and the second hydrogen storage unit. The inlet port of each storage unit can be coupled to a hydrogen charging port by a hydrogen conduit and the outlet port can be coupled to the at least one fuel cell by the hydrogen conduit. The first hydrogen storage unit and the second hydrogen storage unit each can store at least two kilograms of hydrogen. The hydrogen storage assembly can store a quantity of hydrogen sufficient to output between 250 kilowatt hours and 2 megawatt hours of energy. The power converter can comprise a first blade that applies a first conversion to the raw power in order to output a first converted power and a second blade that applies a second conversion to the raw power in order to output a second converted power. In the hydrogen powered generator, the first blade can connect to a first pair of tabs electrically coupled to the at least one fuel cell and the second blade can connect to a second pair of tabs electrically coupled to the at least one fuel cell. In the hydrogen powered generator, the power converter can be configured for removal of at least one of the first blade and the second blade and for replacement with at least one of a third blade and a fourth blade.

In another example embodiment, the present disclosure is directed to a hydrogen powered generator that uses a tray system for hydrogen storage units. The hydrogen powered generator includes at least a first tray and a second tray. The first tray comprises a first fuel cell and a first plurality of hydrogen storage units. The second tray comprises a second fuel cell and a second plurality of hydrogen storage units. The hydrogen powered generator further includes a power converter that receives a raw power from at least one of the first fuel cell and the second fuel cell and outputs a converted power.

The foregoing example embodiment can include one or more of the following features. The hydrogen powered generator can further comprise: a third tray comprising a third fuel cell and a third plurality of hydrogen storage units; and a fourth tray comprising a fourth fuel cell and a fourth plurality of hydrogen storage units. In the example hydrogen powered generator, each of the hydrogen storage units can store at least two kilograms of hydrogen. In the example hydrogen powered generator, the first tray can comprise a sliding mechanism, such as ball bearings, configured to slide the first tray out of the hydrogen powered generator, and the second tray can comprise a sliding mechanism, such as ball bearings, configured to slide the second tray out of the hydrogen powered generator. The power converter can comprise a first blade configured to output a first converted power and a second blade configured to output a second converted power. The first blade can connect to a first pair of tabs electrically coupled to at least one of the first fuel cell and the second fuel cell and the second blade can connect to a second pair of tabs electrically coupled to the at least one of the first fuel cell and the second fuel cell. The power converter can be configured for removal of at least one of the first blade and the second blade and for replacement with at least one of a third blade and a fourth blade

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments of hydrogen powered generators and therefore are not to be considered limiting of the scope of this disclosure. The principles illustrated in the example embodiments of the drawings can be applied to alternate methods and apparatus. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 is a block diagram illustrating a generator and a portable power distribution box in accordance with the prior art.

FIG. 2 is a block diagram of a hydrogen powered generator in accordance with the example embodiments of the disclosure.

FIGS. 3, 4, 5, and 6 provide various views of a hydrogen powered generator in accordance with an example embodiment of the disclosure.

FIGS. 7 and 8 provide front and top views of a hydrogen powered generator in accordance with another example embodiment of the disclosure.

FIG. 9 illustrates the exterior of a hydrogen storage unit in accordance with an example embodiment of the disclosure.

FIG. 10 is a cross-sectional view illustrating the interior of the hydrogen storage unit of FIG. 9 in accordance with an example embodiment of the disclosure.

### DETAILED DESCRIPTION OF EXAMPLE EMBODIMENTS

The example embodiments discussed herein are directed to a generator that is powered by hydrogen. Specifically, hydrogen is absorbed by and stored in metal alloy material within multiple hydrogen storage units. The multiple hydrogen storage units are stored within the generator and supply hydrogen to one or more fuel cells when needed. The fuel cells provide power to a power converter that can convert and output power at a desired voltage, amperage, and phase. The generator can be used for primary power or can be stored for extended lengths of time and provide back-up power when needed. The flexibility of the hydrogen powered generator provides several advantages.

Prior art generators typically are paired with a portable distribution box to provide power at the desired voltage, amperage, and phase as needed for a particular application. However, prior art generators and distribution boxes typically are not configurable. In other words, if particular equipment requires a different form of power than provided by the distribution box on hand, then one is required to obtain another distribution box for coupling with the generator. In contrast, the hydrogen powered generator described herein has an integrated power converter that accommodates swappable blades. Each of the blades can be configured to provide power having a particular voltage, current, and phase, thereby making the power output from the hydrogen powered generator configurable.

The design of the hydrogen powered generator allows the hydrogen storage units to be easily recharged with hydrogen when the stored hydrogen has been depleted. The hydrogen storage units optimize the storage of hydrogen gas in a plurality of storage chambers wherein each chamber contains metal alloy material. The hydrogen gas is adsorbed and absorbed by the metal alloy material producing a metal hydride. The metal hydride stored within the hydrogen storage units is very stable allowing it to be easily transported and stored for several years with very little hydrogen loss. The hydrogen storage unit also is optimized to maximize the quantity of hydrogen stored within the volume of the unit. The hydrogen storage unit can be easily combined with multiple hydrogen storage units into an assembly. The configuration of the hydrogen storage unit facilitates the use of hydrogen in the generators described herein. As will be described further in the following examples, the methods and apparatus described herein improve upon prior approaches to using hydrogen as a power source.

While the example embodiments described herein are directed to generators powered by stored hydrogen gas, it should be understood that the generators described herein also can be powered using other types of gases. Examples of gases that can be stored in the storage units to power the generators described herein include hydrogen, methane, ethane, propane, butane, hythane (hydrogen/methane), and combinations of the foregoing.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

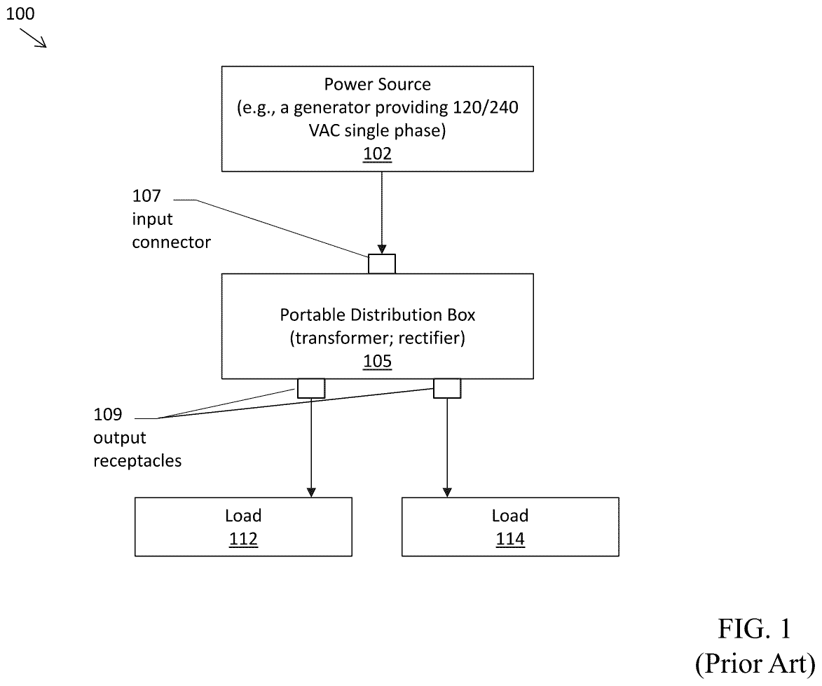

Referring now to FIG. 1, an example of a prior art system is illustrated. Prior art system 100 includes a power source such as a generator 102 that provides power generated by an internal combustion engine that burns a fuel such as gasoline or propane. The generator 102 can have one or more output receptacles providing an output power, such as 120 VAC or 240 VAC. The generator 102 is coupled with a portable distribution box 105. The portable distribution box 105 has an input connector 107 to receive input power from the generator 102. The portable distribution box 105 also includes one or more power converters, such as a transformer, buck converter, or rectifier, to modify the input power and provide an output power at output receptacles 109. The output power can be provided to load 112 and load 114.

As illustrated in FIG. 1, one of the shortcomings of the prior art system 100 is that a generator must be coupled with a portable distribution box to adapt the generator's power to the voltage, amperage, and phase requirements of the equipment that receives power. The power requirements of equipment at a site can vary widely. If the appropriate distribution box is not available, another distribution box must be obtained that provides power in the required form. In contrast, as will be described further below, the hydrogen powered generators described herein provide a single system that integrates a clean power source with a power converter. The clean power provided by hydrogen and fuel cells can be safely stored for long periods of time. Additionally, the storage assembly of the hydrogen powered generator can be easily recharged with additional hydrogen when the stored hydrogen is depleted. Additional advantages of the hydrogen powered generator will be apparent in the following description of the example embodiments.

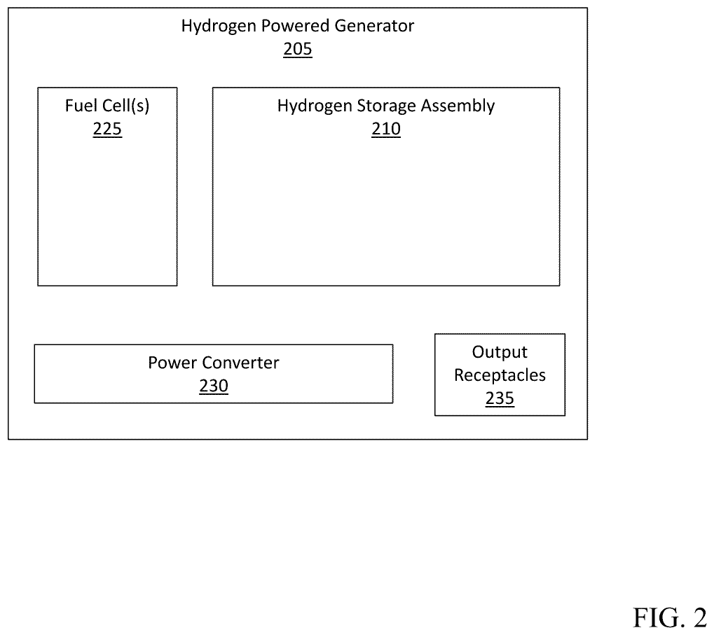

Referring now to FIG. 2, a block diagram is provided illustrating the primary components of a hydrogen powered generator 205 in accordance with an example embodiment of this disclosure. The hydrogen powered generator 205 includes a hydrogen storage assembly 210 that stores hydrogen to be used in one or more fuel cells 225. As referenced previously and as described further below, the hydrogen storage assembly 210 can comprise one or more hydrogen storage units containing metal alloy material that absorbs and adsorbs gaseous hydrogen forming a metal hydride. The metal hydride is a stable composition that can be safely stored for months or years. When power is needed, the hydrogen can be released from the hydrogen storage units and can be used by the one or more fuel cells 225 to generate electrical power. The one or more fuel cells 225 can be electrochemical fuel cells, as known to those in the field, that use hydrogen, oxygen, an anode, a cathode, and an electrolyte to generate a direct current.

The fuel cells 225 typically output DC power. The hydrogen powered generator 205 includes one or more power converters 230 to modify the power output by the fuel cells 225 to a particular voltage, current, and phase. The power converters can be one or more blades that slide into and out of the hydrogen powered generator. Each blade can comprise the electrical components, such as one or more of transformers, inverters, and boost or buck converters, needed to convert the power from the fuel cells as well as a metering component for measuring the amount of power delivered. In some cases, the blades can be similar to a backplane comprising slots for power conversion components as well as one or more processors for intelligently controlling the power conversion and delivery. The power converter 230 can be configured so that blades can easily slide into and out of the power converter to meet various power requirements. Once the converters modify the power, an output power is delivered to one or more output receptacles 235.

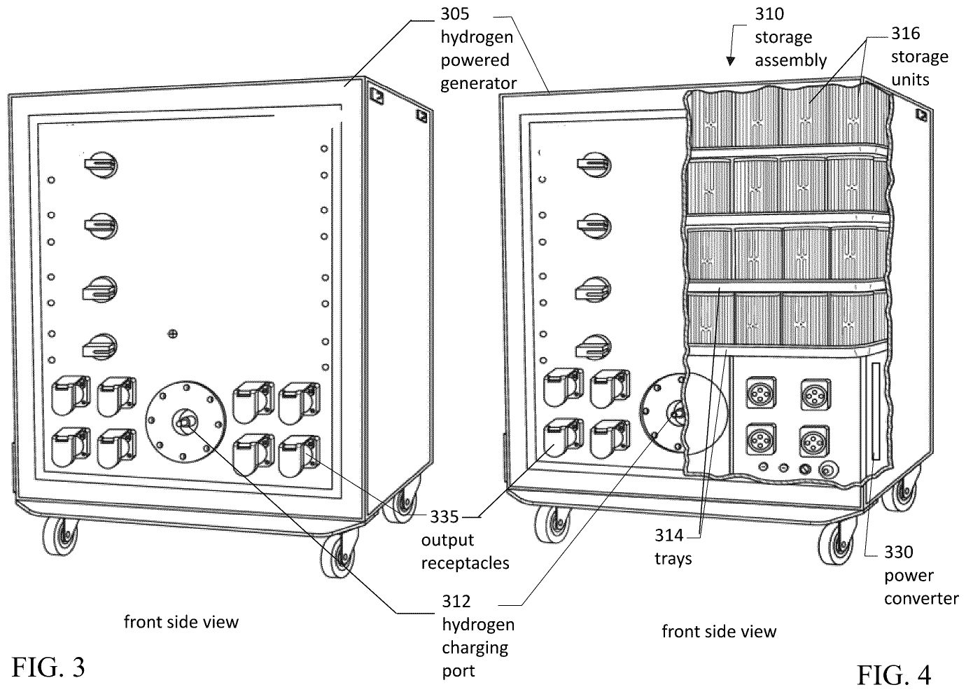

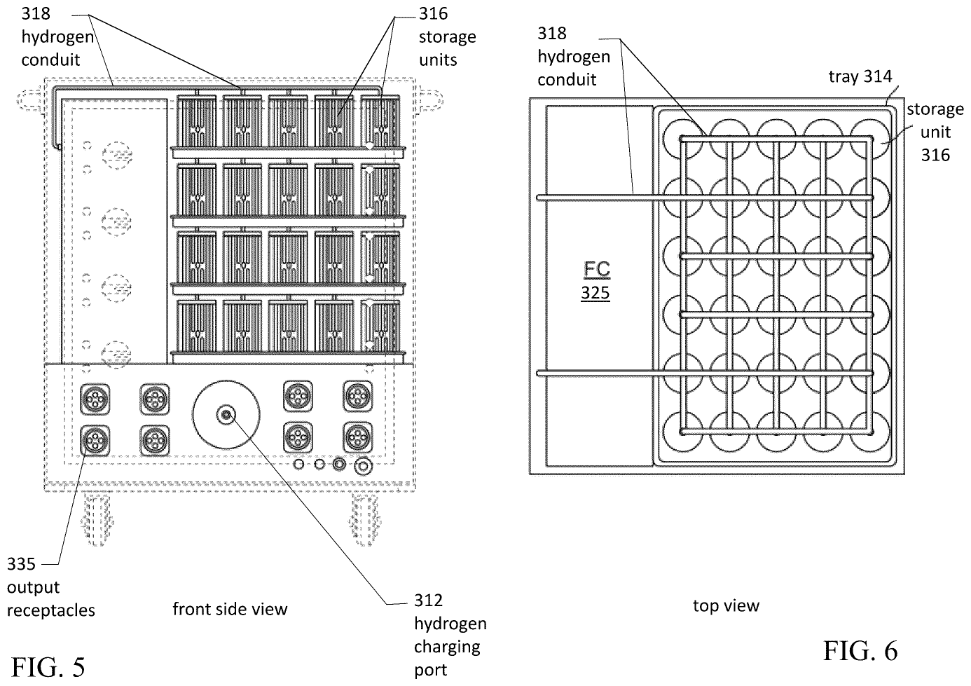

Referring now to FIGS. 3, 4, 5, and 6, another example embodiment of a hydrogen powered generator is illustrated. FIG. 3 provides a front side view of the exterior of the example hydrogen powered generator 305. FIG. 4 illustrates a partial cutaway illustration showing interior components of the hydrogen powered generator 305. In FIG. 5, the front panel of the generator has been removed to illustrate additional portions of the interior. In FIG. 6, the top of the generator has been removed and an interior view of the top of the generator is illustrated. Hydrogen powered generator 305 includes a storage assembly 310, fuel cells 325, one or more power converters 330, and output receptacles 335.

The storage assembly 310 comprises four trays 314 and mounted on each tray is a plurality of hydrogen storage units 316. In certain embodiments, one of the side panels of the generator can be opened and the trays 314 can slide out of the generator to facilitate maintenance or replacement of the storage units 316. In the example of generator 305, each tray 314 holds 30 cylindrical hydrogen storage units 316. Each of the hydrogen storage units 316 includes a port at the top of the unit through which hydrogen can be injected and released from the storage unit. As illustrated in FIG. 6, each port at the tops of the hydrogen storage units 316 can be connected to a hydrogen conduit 318. One end of the hydrogen conduit 318 can be coupled to the fuel cell(s) 325 for supplying hydrogen to generate electricity. The opposite end of the hydrogen conduit 318 can be coupled to the hydrogen charging port 312 located on the exterior of the generator 305. The hydrogen charging port 312 allows pumping of new hydrogen gas into the storage units 316 when the storage units 316 have been depleted of hydrogen. In certain embodiments, a gauge can be located on the exterior of the generator to indicate the amount of hydrogen that is pumped into the storage units 316 and the amount of hydrogen that is depleted from the storage units 316. It should be understood that the configuration of the trays 314, the hydrogen storage units 316, and the hydrogen conduit 318 illustrated in FIGS. 3-6 is one example and in alternate embodiments these components can have other shapes and configurations.

As illustrated in FIGS. 5 and 6, the fuel cell(s) 325 can be stacked adjacent to the trays 314 and storage units 316. Although not visible in FIGS. 5 and 6, the example generator 305 has four fuel cells 325 stacked on top of each other, with one fuel cell corresponding to each of the four trays of storage units 316. In other embodiments, the width of the tray can be extended and a fuel cell can be mounted onto each tray. The fuel cell 325 combines the hydrogen from the storage units with oxygen to output electricity and water as is known to those in the field of hydrogen fuel cells. The fuel cell typically includes a delivery valve system controlling the flow of hydrogen into the fuel cell, a relief valve used in case of pressure build up, and a power controller that controls the raw power output from the fuel cell. The raw power generated by the fuel cells is in the form of a DC current. As one example, each fuel cell can generate 48 VDC of raw power. When the generator has multiple fuel cells, the raw power outputs of the fuel cells are configured in parallel so that one fuel cell or tray can be taken off line for maintenance or replacement while the other fuel cells and trays continue to delivery power.

The power converter 330 can receive the raw power from the fuel cell(s) 325 and convert it to an output power of the type needed by the equipment that is connected to the generator 305. As illustrated in FIG. 4, the power converter 330 can comprise a blade containing the appropriate power conversion components, such as one or more of transformers, inverters, and boost or buck converters, needed to convert the power from the fuel cells. In certain embodiments, the power converter 330 can comprise multiple blades, each of which provides a different output power to meet varying requirements. The blades can be configured so that they easily slide in and out of the side panel of the generator 305 so that they can be replaced with other blades providing other types of power when needed. The blades can be configured with contacts that connect to conductive tabs that electrically couple the blades to the fuel cells. Lastly, the output power from the power converter 330 is made available at one or more output receptacles 335 located on the exterior of the generator 305.

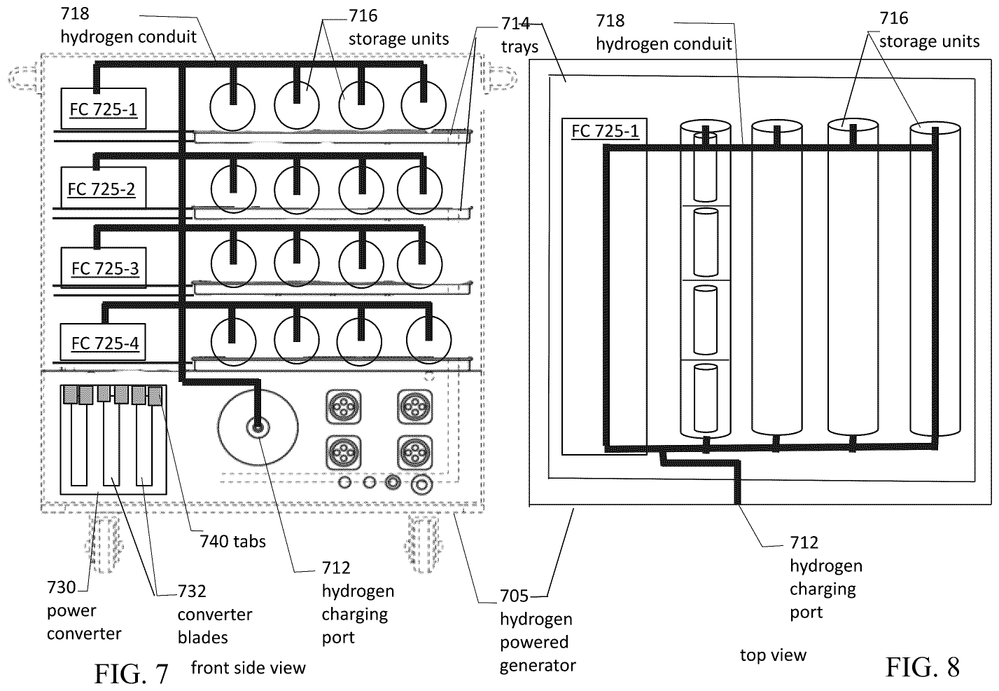

Referring now to FIGS. 7 and 8, another example embodiment of a hydrogen powered generator is illustrated. FIG. 7 illustrates interior components of hydrogen powered generator 705 after the front panel has been removed. In FIG. 8, the top panel has been removed to provide a top view of interior components of the hydrogen powered generator 705. Hydrogen powered generator 705 includes primary components that are similar to the components of the previously described example embodiments.

With respect to hydrogen storage, hydrogen powered generator 705 includes four trays 714 mounted horizontally within the generator, as viewed in the front side view of FIG. 7. In certain embodiments, a side panel of the generator 705 can be opened and the trays can slide out of the generator to perform maintenance on or replace one or more of the hydrogen storage units 716. In the example of FIGS. 7 and 8, each tray holds four hydrogen storage units 716 as well as one of the fuel cells 725-1, 725-2, 725-3, or 725-4. The hydrogen storage units 716 differ from the previously described hydrogen storage units in that they are longer and are laid on their side on each tray 714. The hydrogen storage units 716 have a port on each end of the unit for injecting and releasing hydrogen. In certain embodiments, the ports can be configured with one-way valves so that the port on one end is configured for injecting hydrogen into the storage unit while the port at the opposite end is configured for releasing hydrogen from the storage unit. In other embodiments, the ports can be two-way ports that permit hydrogen to flow into and out of the storage unit.

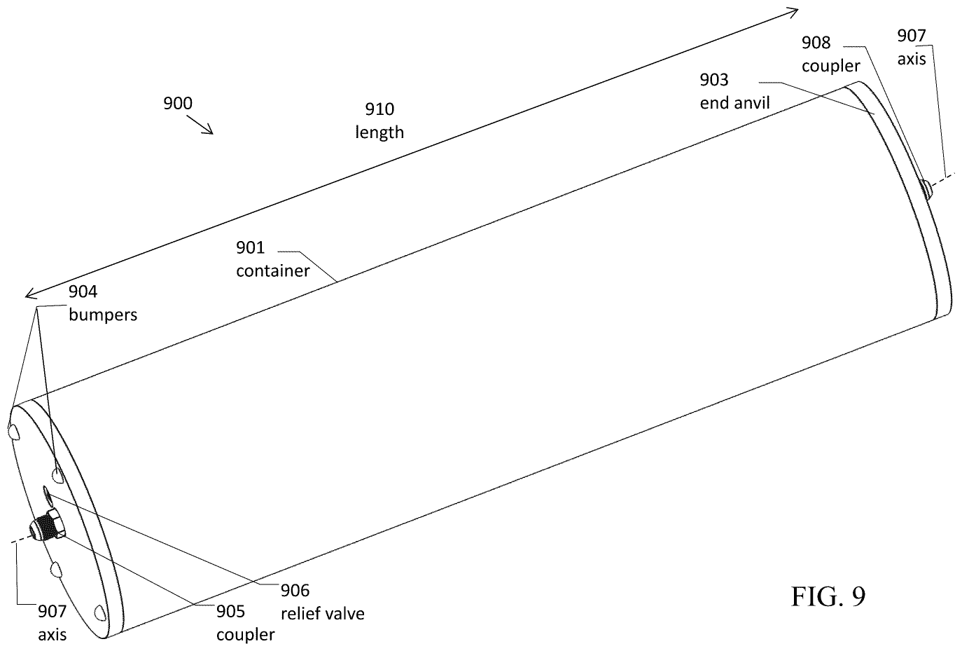

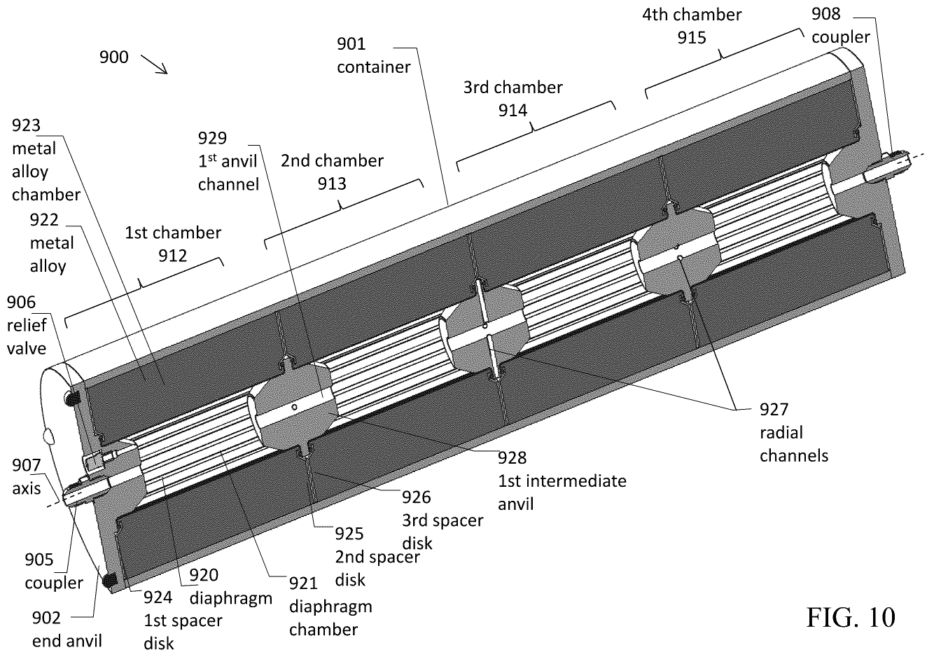

The example hydrogen storage units 716 are cylindrical in shape and contain multiple interior chambers to maximize the hydrogen storage capacity. As illustrated by the interior view of one of the storage units in FIG. 8, each of the interior chambers has a cylindrical diaphragm defining an inner cavity within the cylindrical diaphragm and an outer cavity between the exterior surface of the diaphragm wall and the interior surface of the wall of the cylinder. The outer cavity contains metal alloy material that absorbs and adsorbs hydrogen gas for storage. A more detailed example of a cylindrical hydrogen storage unit is illustrated in FIGS. 9 and 10.

As illustrated in FIGS. 7 and 8, each tray can have a hydrogen conduit 718 that is coupled to each port at the opposite ends of the hydrogen storage units 716. One end of the hydrogen conduit 718 can be coupled to the fuel cell on each tray for supplying hydrogen to generate electricity. Each hydrogen conduit 718 on each tray also can be connected to the hydrogen charging port 712 located on the exterior of the generator 705. The hydrogen charging port 712 allows pumping of new hydrogen gas into the storage units 716 when the storage units 716 have been depleted of hydrogen. Accordingly, new hydrogen gas can be pumped into the hydrogen charging port 712, pass through the hydrogen conduit 718, and into a port of the storage units 716. When the fuel cells are operating, the hydrogen conduit 718 delivers hydrogen from a port of a storage unit 716 to a fuel cell.

In certain embodiments, a gauge can be located on the exterior of the generator to indicate the amount of hydrogen that is pumped into the storage units 716 and the amount of hydrogen that is depleted from the storage units 716. It should be understood that the configuration of the trays 714, the hydrogen storage units 716, and the hydrogen conduit 718 illustrated in FIGS. 7 and 8 is one example and in alternate embodiments these components can have other shapes and configurations.

Each fuel cell 725-1, 725-2, 725-3, and 725-4 can receive hydrogen via the hydrogen conduit 718 from the hydrogen storage units 716 on its respective tray. As explained previously, the fuel cells combine the hydrogen from the storage units with oxygen to output electricity and water as is known to those in the field of hydrogen fuel cells. Each fuel cell typically includes a delivery valve system controlling the flow of hydrogen into the fuel cell from the storage units, a relief valve used in case of pressure build up, and a power controller that controls the raw power output from the fuel cell. The raw power generated by the fuel cells is in the form of a DC current. As one example, each fuel cell can generate 48 VDC of raw power. The four fuel cells of the example generator in FIG. 7 are configured in parallel so that one fuel cell or tray can be taken off line for maintenance or replacement while the other fuel cells and trays continue to delivery power.

The power converter 730 can receive the raw power from the fuel cells and convert it to an output power of the type needed by the equipment that is connected to the generator 705. As illustrated in FIG. 7, the power converter 730 can comprise multiple blades, each containing the appropriate power conversion components, such as one or more of transformers, inverters, and boost or buck converters, needed to convert the power from the fuel cells. Each of the blades can provide a different output power to meet varying requirements. The blades can be configured so that they easily slide in and out of the power converter 730 so that they can be replaced with other blades providing other types of power when needed. The blades can be configured with contacts that connect to conductive tabs 740 that electrically couple the blades to the fuel cells. Lastly, the output power from the power converter 730 is made available at one or more output receptacles located on the exterior of the generator 705.

With respect to output power, as an example, each of the hydrogen storage units 716 can store approximately 2 kilograms of hydrogen. Therefore, with four cylindrical storage units 716 on each tray 714, each tray 714 contains 8 kilograms of hydrogen which results in 266 kW hours of storage capacity per tray and a total of 1,064 kW hours of storage capacity for the 4 trays. Assuming the fuel cells operate at 50% efficiency, the generator 705 is capable of providing 532 kW hours of power. In some examples, the generators can be grouped or stacked to achieve larger amounts of output power.

Referring now to FIG. 9, a perspective view of the outside of example hydrogen storage unit 900 is illustrated. Hydrogen storage unit 900 is a representative example of the hydrogen storage units described previously in association with FIGS. 7 and 8. Hydrogen storage unit 900 has a length 910 and is generally rotationally symmetrical about a central longitudinal axis 907. Hydrogen storage unit 900 comprises a cylindrical cavity formed by cylindrical container 901, a first end anvil 902, and a second end anvil 903. When attached to the cylindrical container 901, the first end anvil 902 and second end anvil 903 form an enclosure for storing hydrogen or other gases. The first end anvil 902 and second end anvil 903 comprise couplers 905 and 908 that can connect the hydrogen storage unit 900 to the previously described hydrogen conduit or to other appropriate equipment. Each coupler can include a port and a valve for controlling the flow of hydrogen into and out of the gas storage unit 900. As an example, when charging the hydrogen storage unit 900 with hydrogen, the hydrogen can be pumped into one or both of the couplers 905, 908 at pressures ranging from 55 kPa (8 psi) to 2758 kPa (400 psi). One or both of the end anvils can be removably coupled to the cylindrical container 901 using fasteners such as bolts or other types of fastening devices. Additionally, the end anvils 902, 903 also can include bumpers 904 that protect the gas storage unit 900 from impacts. Although the container 901 is cylindrical with a generally circular shape when a cross-section is taken perpendicular to the central longitudinal axis 907 in the example of FIG. 9, it should be understood that in alternate embodiments the container can take other shapes such that the cross-section is elliptical or polygonal.

Referring now to FIG. 10, the gas storage unit 900 of FIG. 9 is shown in cross-section along the central longitudinal axis 907. As can be seen in FIG. 10, the gas storage unit 900 comprises four gas storage chambers—a first chamber 912, a second chamber 913, a third chamber 914, and a fourth chamber 915. In other embodiments, the gas storage units can comprise a fewer or greater number of gas storage chambers. The gas storage chambers are separated by intermediate anvils and spacer disks. Each gas storage chamber comprises a diaphragm that will be described in greater detail below. The following description provides details regarding the first chamber 912. It should be understood that the second, third, and fourth chambers are similar to the first chamber and, therefore, the descriptions of the first chamber can also apply to the features of the second, third, and fourth chambers.

As illustrated in FIG. 10, the first chamber 912 is defined by end anvil 902, first intermediate anvil 928, and the inner surface of the cylindrical container 901. A first spacer disk 924 is adjacent to the end anvil 902 and a second spacer disk 925 is adjacent the first intermediate anvil 928. A diaphragm 920 extends from the end anvil 902 and first spacer disk 924 at one end of the first chamber 912 to the first intermediate anvil 928 and second spacer disk 925 at the other end of the first chamber 912. An interior portion of the chamber, referred to as the diaphragm chamber 921, is defined by an inner surface of the diaphragm and the anvils located at opposing ends of the diaphragm. An outer portion of the chamber, referred to as the metal alloy chamber 923, is in the shape of an annulus and is defined by an outer surface of the diaphragm, an inner surface of the cylindrical container and the spacer disks located at opposing ends of the diaphragm. The metal alloy material 922 is positioned in the metal alloy chamber 923 between the outer surface of the diaphragm and the inner surface of the cylindrical container 901. In this way, the diaphragm and spacer disks hold the metal alloy in place in each gas storage chamber.

The metal alloy 922 is of a type that can absorb hydrogen gas to form a metallic hydride. The metal alloy can comprise any combination of the following materials: nickel, tin, aluminum, manganese, iron, cobalt, copper, titanium, antimony, and rare earth metals such as yttrium, lanthanum, cerium, prascodymium, and neodymium. The metal alloy is typically a granular material that forms a porous composition and may include a binding agent. The metal alloy granules can have a D50 particle size from 1.0 microns, or 1.5 microns, or 2.0 microns to 2.5 microns, or 3.0 microns, or 4.0 microns, or 5.0 microns. In one example, the D50 particle size of the metal alloy granules ranges from 1.5 microns to 2.0 microns. The term “D50” refers to the median diameter of the metal alloy granules such that 50% of the sample weight is above the stated particle diameter.

With each charging and discharging of the gas storage unit, hydrogen can flow between the coupler 905 and the metal alloy 922. Taking the charging of the gas storage unit 900 as an example, the hydrogen gas can enter the cylindrical container 901 through coupler 905, pass into the diaphragm chamber 921, and pass through the anvil channel of each intermediate anvil to flow into the next diaphragm chamber of the second, third, and fourth chambers. The flow of hydrogen between the diaphragm chambers and the metal alloy can take one or more paths depending upon the particular embodiment of the gas storage unit 900. In one example embodiment, each diaphragm comprises a semi-permeable material that permits gaseous hydrogen to pass through the diaphragm and back and forth between the diaphragm chamber and the metal alloy chamber during charging and discharging of the gas storage unit 900. The hydrogen gas passes from the inner portion of the chamber through the semi-permeable membrane of each diaphragm and is stored in the metal alloy material in the outer portion of each chamber. Examples of the semi-permeable material of the diaphragm include, but are not limited to, polymeric materials such as polyethylene and polypropylene, as well as composite materials.

In another example embodiment, the hydrogen gas can pass between the diaphragm chambers and the metal alloy chambers via one or more radial channels 927 located in the intermediate anvils. As illustrated in FIG. 10, each intermediate anvil includes an anvil channel, such as anvil channel 929, that extends along the longitudinal axis 907 of the gas storage unit. Additionally, each intermediate anvil can include one or more radial channels 927 that provide a passage for the hydrogen gas to flow between the anvil channel and the metal alloy chamber. Although not visible in FIG. 10, a filter within or adjacent to the radial channels can permit the flow of hydrogen gas while preventing the metal alloy materials from escaping through the radial channels.

In yet another example embodiment, the intermediate anvils and spacer disks can include one or more ports permitting the flow of hydrogen between the diaphragm chamber and the metal alloy chamber. Moreover, other example embodiments can include combinations of the foregoing examples, such as an embodiment that includes both a hydrogen permeable membrane and radial channels in the intermediate anvils so that there is more than one path for the hydrogen to flow within each chamber.

When absorbed by the metal alloy material, the hydrogen gas can be stored in a stable and secure manner. When discharging hydrogen from the gas storage unit 100, the hydrogen gas flows from the metal alloy material in each chamber, through one of the previously described paths and into the diaphragm chamber from which it can exit through the channels passing through each anvil.

Referring to the first gas storage chamber 912, the diaphragm 920 is held in place between the end anvil 902 and the first intermediate anvil 928. The first disk spacer 924 is placed on the inner surface of the end anvil 902 and further secures one end of the diaphragm 920. At the opposite end of the first gas storage chamber 912, a second disk spacer 925 surrounds the first intermediate anvil 928 and secures the opposite end of the diaphragm 920. Each of the second chamber 913, the third chamber 914, and fourth chamber 915 has a similar arrangement to the first gas storage chamber 912.

Examples of suitable materials for the cylindrical container 901, the end anvils 902, 903, the intermediate anvils 928, and the spacer disks 924, 925, 926 include metals, polymeric materials, nanomaterials, and combinations thereof. Examples of suitable metals include aluminum, aluminum alloys, copper, steel, and combinations thereof. Examples of suitable polymeric material for the cylinder include carbon fiber, polyolefin, polycarbonate, acrylate, fiberglass, Ultem, and combinations thereof. The cylindrical container and its components may be a combination of metal and polymeric material such as a metal liner thermoset in a polymeric resin, for example.

In an embodiment, the cylindrical container 901 is composed of a heat conductive material. The metal alloy is packed against the inner surface of the cylindrical container 901 to facilitate the exchange of heat. The heat conductive material promotes heat dissipation (cooling) during charging of the gas storage unit with hydrogen and promotes warming during discharging of hydrogen from the gas storage unit. In this way, the cylindrical container functions as a heat exchanger and the gas storage unit eliminates the need for a separate heat exchanger and/or a separate coolant system. The structure and composition of the gas storage unit advantageously promotes energy efficiency, case-of-use, case-of-production, and reduction in weight.

For any apparatus shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

Referring generally to the examples herein, any components of the apparatus described herein can be made from a single piece (e.g., as from a mold, injection mold, die cast, 3-D printing process, extrusion process, stamping process, or other prototype methods). In addition, or in the alternative, a component of the apparatus can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, and slotted fittings. One or more pieces that are mechanically coupled to each other can be coupled to each other in one or more of a number of ways, including but not limited to couplings that are fixed, hinged, removeable, slidable, and threaded.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation, and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Although example embodiments are described herein, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A hydrogen powered generator comprising:
at least one fuel cell;
a power converter that receives a raw power from the at least one fuel cell and outputs a converted power; and
a hydrogen storage assembly that supplies hydrogen to the at least one fuel cell, the hydrogen storage assembly comprising a first hydrogen storage unit in fluid communication with the at least one fuel cell and a second hydrogen storage unit in fluid communication with the at least one fuel cell.

2. The hydrogen powered generator of claim 1, wherein the first hydrogen storage unit and the second hydrogen storage unit are cylindrical and comprise a metal alloy material that absorbs and releases hydrogen gas.

3. The hydrogen powered generator of claim 1, wherein the hydrogen storage assembly comprises a tray that slides out of the hydrogen powered generator, wherein the first hydrogen storage unit and the second hydrogen storage unit are mounted on the tray.

4. The hydrogen powered generator of claim 3, wherein the at least one fuel cell is mounted on the tray.

5. The hydrogen powered generator of claim 1, wherein the first hydrogen storage unit and the second hydrogen storage unit each have a port for injecting hydrogen into and releasing hydrogen from the first hydrogen storage unit and the second hydrogen storage unit.

6. The hydrogen powered generator of claim 1, wherein the first hydrogen storage unit and the second hydrogen storage unit are each subdivided into multiple chambers, each of the multiple chambers comprising a metal alloy material that absorbs and releases hydrogen gas.

7. The hydrogen powered generator of claim 6, wherein the first hydrogen storage unit and the second hydrogen storage unit each comprise an inlet port and an outlet port at opposite ends of the first hydrogen storage unit and the second hydrogen storage unit.

8. The hydrogen powered generator of claim 7, wherein the inlet port is coupled to a hydrogen charging port by a hydrogen conduit and the outlet port is coupled to the at least one fuel cell by the hydrogen conduit.

9. The hydrogen powered generator of claim 8, wherein the first hydrogen storage unit and the second hydrogen storage unit each stores at least two kilograms of hydrogen.

10. The hydrogen powered generator of claim 1, wherein the hydrogen storage assembly stores a quantity of hydrogen sufficient to output between 250 kilowatt hours and 2 megawatt hours of energy.

11. The hydrogen powered generator of claim 1, wherein the power converter comprises a first blade that applies a first conversion to the raw power in order to output a first converted power and a second blade that applies a second conversion to the raw power in order to output a second converted power.

12. The hydrogen powered generator of claim 11, wherein the first blade connects to a first pair of tabs electrically coupled to the at least one fuel cell and the second blade connects to a second pair of tabs electrically coupled to the at least one fuel cell.

13. The hydrogen powered generator of claim 11, wherein the power converter is configured for removal of at least one of the first blade and the second blade and for replacement with at least one of a third blade and a fourth blade.

14. A hydrogen powered generator comprising:
a first tray comprising a first fuel cell and a first plurality of hydrogen storage units;
a second tray comprising a second fuel cell and a second plurality of hydrogen storage units; and
a power converter that receives a raw power from at least one of the first fuel cell and the second fuel cell and outputs a converted power.

15. The hydrogen powered generator of claim 14, further comprising:
a third tray comprising a third fuel cell and a third plurality of hydrogen storage units; and
a fourth tray comprising a fourth fuel cell and a fourth plurality of hydrogen storage units.

16. The hydrogen powered generator of claim 14, wherein each of the hydrogen storage units stores at least two kilograms of hydrogen.

17. The hydrogen powered generator of claim 14, wherein:
the first tray comprises a sliding mechanism configured to slide the first tray out of the hydrogen powered generator, and
the second tray comprises a sliding mechanism configured to slide the second tray out of the hydrogen powered generator.

18. The hydrogen powered generator of claim 14, wherein the power converter comprises a first blade configured to output a first converted power and a second blade configured to output a second converted power.

19. The hydrogen powered generator of claim 18, wherein the first blade connects to a first pair of tabs electrically coupled to at least one of the first fuel cell and the second fuel cell and the second blade connects to a second pair of tabs electrically coupled to the at least one of the first fuel cell and the second fuel cell.

20. The hydrogen powered generator of claim 18, wherein the power converter is configured for removal of at least one of the first blade and the second blade and for replacement with at least one of a third blade and a fourth blade.
